(19) United States
(12) Patent Application Publication
(10) Pub. No.: US 2023/0187999 A1
(43) Pub. Date: Jun. 15, 2023

(54) DRIVE MOTOR, DRIVE SYSTEM HAVING DRIVE MOTOR AND VEHICLE

(71) Applicants: ANHUI WELLING AUTO PARTS CO., LTD., Hefei (CN); GUANGDONG WELLING AUTO PARTS CO., LTD., Foshan (CN)

(72) Inventors: Fei WANG, Hefei (CN); Jintao CHEN, Hefei (CN); Xiaomin PU, Hefei (CN); Yiming HU, Hefei (CN)

(73) Assignees: ANHUI WELLING AUTO PARTS CO., LTD., Hefei (CN); GUANGDONG WELLING AUTO PARTS CO., LTD., Foshan (CN)

(21) Appl. No.: 18/095,734

(22) Filed: Jan. 11, 2023

Related U.S. Application Data
(63) Continuation of application No. PCT/CN2021/110150, filed on Aug. 2, 2021.

(30) Foreign Application Priority Data
Aug. 3, 2020 (CN) 202010768996.6
Aug. 3, 2020 (CN) 202010771190.2
Aug. 3, 2020 (CN) 202021586557.5
Aug. 3, 2020 (CN) 202021586558.X

(51) Int. Cl. H02K 5/20; H02K 9/19; H02K 1/12; H02K 11/30

(52) U.S. Cl. CPC H02K 5/203; H02K 9/19; H02K 1/12; H02K 11/30

(57) ABSTRACT

A drive motor, a drive system and a vehicle are provided. The drive motor has a motor housing and a stator core provided in the motor housing. The motor housing has a fluid inlet and a fluid outlet. A cut edge is disposed on an outer peripheral wall of the stator core. The cut edge extends in an axial direction of the stator core. A cooling fluid flow path is formed by a space between the cut edge and an inner peripheral wall of the motor housing. The fluid inlet and the fluid outlet are in communication with the cooling fluid flow path.

### CROSS-REFERENCE TO RELATED APPLICATIONS

This application is a continuation application of PCT International Application No. PCT/CN2021/110150, which claims priority to and benefits of Chinese Patent Application No. 202010771190.2, field on Aug. 3, 2020 and Chinese Patent Application No. 202021586557.5, field on Aug. 3, 2020 and Chinese Patent Application No. 202010768996.6, field on Aug. 3, 2020 and Chinese Patent Application No. 202021586558.X, field on Aug. 3, 2020, the entire contents of which are incorporated herein by reference for all purpose. No new matter has been introduced.

### FIELD

The present disclosure relates to the field of motor technologies, and more particularly, to a drive motor, a drive system having the drive motor, and a vehicle having the drive motor.

### BACKGROUND

A main drive motor is an important component of an electric vehicle. The main drive motor is different from a traditional motor that is used by a device such as a compressor. When the drive motor operates, since the iron losses and the copper losses of a stator assembly generate a great amount of heat, in condition of a poor cooling system, both the stator assembly and the rotor assembly of the drive motor may cause overheating and high temperature, which results in an demagnetization of the rotor magnet steel of the drive motor, and a burnout of the stator coil packet of the drive motor, and the like, which affects normal operation of the motor. Therefore, a heat dissipation design of a transmission motor cannot meet the heat dissipation requirements of the drive motor. In the related art, a cut edge disposed on an outer wall of a stator core is provided to improve the heat dissipation effect. However, the inventors of the present disclosure have found by studying the designing scheme that the cooling effect of the drive motor still cannot meet the heat dissipation requirements, and there is still room for improvement in the cooling effect.

### SUMMARY

The present disclosure aims to solve at least one of the technical problems in the related art to some extent.

To this end, embodiments of the present disclosure provide a drive motor with an improved cooling effect.

Certain embodiments of the present disclosure further provide a drive system having the drive motor described above.

Certain embodiments of the present disclosure further provide a vehicle having the drive motor described above.

According to certain embodiments of the present disclosure, a drive motor includes a motor housing in which having a fluid inlet and a fluid outlet; and a stator core mounted in the motor housing, an outer peripheral wall of the stator core having at least one cut edge extending in an axial direction of the stator core. A cooling fluid flow path is formed by a space between the cut edge and an inner peripheral wall of the motor housing. The fluid inlet and the fluid outlet are in communication with the cooling fluid flow path. The cut edges has a depth satisfying a relationship of

$$b = \frac{{k}_{2} Lh}{{R}_{out} - {R}_{in}} ,$$

where b is the depth of the cut edges, Rₒᵤₜ is an outer diameter of the stator core, Rᵢₙ is an inner diameter of the stator core, L is a yoke thickness of the stator core, h is a stacking thickness of the stator core, and k₂ is a coefficient ranging from 0.05 to 0.1.

According to certain embodiments of the present disclosure, by properly arranging the position and parameters of the cut edge, the drive motor can increase a contact area between cooling fluid and the stator core, thereby improving the heat dissipation efficiency of a motor under high power. Further, it is possible to obtain a better heat dissipation effect by limiting the depth of the cut edge within the above range.

In some embodiments, a stator groove is defined on the outer peripheral wall of the stator core and extends in an axial direction of the stator core. The stator groove is in communication with the fluid inlet and the fluid outlet.

In some embodiments, the stator groove is of a rectangular shape. The stator groove has a depth satisfying a relationship of

$$a = \frac{{k}_{1} Lh}{{R}_{out} - {R}_{in}} ,$$

where α is the depth of the stator groove, Rₒᵤₜ is the outer diameter of the stator core, Rᵢₙ is the inner diameter of the stator core, L is the yoke thickness of the stator core, h is the stacking thickness of the stator core, and k₁ is a coefficient ranging from 0.05 to 0.1.

In some embodiments, a plurality of stator grooves are divided into a plurality of groups of stator grooves, and the plurality of groups of stator grooves is evenly distributed at intervals in a circumferential direction of the stator core. A central angle θ₁ corresponding to a spacing between adjacent groups of stator grooves ranges from 1 degree to 5 degrees.

In some embodiments, the plurality of groups of stator grooves is divided into first groove groups and second groove groups that are arranged alternately in a circumferential direction of the stator core. The cut edge is located in the second groove groups. Each of the second groove groups is divided into two first sections and two second sections. The two first sections are adjacent to a corresponding first groove groups, and the two second sections are adjacent to a corresponding cut edge. The number of stator grooves of each of the first sections is greater than the number of stator grooves of each of the second sections. A central angle θ₃₂ corresponding to a spacing between a first section and a second section which is adjacent to the first section ranges from 1 degree to 5 degrees. A central angle θ₄₂ corresponding to a spacing between stator grooves of each section ranges from 0.5 degree to 2 degrees. A central angle θ₅₂ corresponding to each of the stator grooves ranges from 0.5 degree to 2 degrees. Each of the first groove groups is divided into a plurality of sets, and each of the plurality of sets includes a plurality of sections. A central angle θ₂₁ corresponding to a spacing between adjacent sets ranges from 1 degree to 5 degrees. A central angle θ₃₁ corresponding to a spacing between adjacent sections of each of the plurality of sets ranges from 1 degree to 5 degrees. A central angle θ₄₁ corresponding to a spacing between stator grooves of each of the plurality of sections of each of the plurality of sets ranges from 0.5 degree to 2 degrees. A central angle θ₅₁ corresponding to each of the stator grooves ranges from 0.5 degree to 2 degrees.

In some embodiments, the stator groove has a depth ranging from 1.5 mm to 2.5 mm.

In some embodiments, a plurality of fluid inlets is provided and spirally distributed along the motor housing.

In some embodiments, a housing groove is defined on the inner peripheral wall of the motor housing, and extends in a circumferential direction of the motor housing. The fluid inlet and the fluid outlet are in communication with the housing groove, respectively.

In some embodiments, a plurality of fluid inlets is provided and distributed in a circumferential direction of the motor housing. An included angle θ between central axes of adjacent fluid inlets is smaller than or equal to 180 degrees. A central angle β between a projection of a center of each fluid inlet and a projection of a center of the cut edge closest to the fluid inlet on a cross section of the stator core ranges from 0 degree to 5 degrees.

In some embodiments, four cut edges and two fluid inlets are provided, and the central angle β is 0 degree.

In some embodiments, four cut edges and four fluid inlets are provided, and the central angle β is 0 degree.

In some embodiments, the four fluid inlets are arranged at intervals in an axial direction of the motor housing.

In some embodiments, the stator core is formed by stacking stator laminations. At least one stator circumferential groove is defined on the outer peripheral wall of the stator core, and extends in a circumferential direction of the stator core, to divide the stator core into a plurality of non-groove core segments and at least one groove core segment in an axial direction of the stator core.

In some embodiments, one groove core segment and two non-groove core segments are provided, and the stator groove and/or the cut edge are disposed on an outer peripheral wall of each of the two non-groove core segments.

In some embodiments, the one groove core segment is located at an axial middle position of the stator core.

In some embodiments, a central axis of the fluid inlet is located in a central cross section of the one groove core segment.

According to embodiments of the present disclosure in a second aspect, a drive system is provided which includes a decelerator, a controller, and the drive motor according to any one of the above embodiments. The decelerator is connected to a motor shaft of the drive motor, and the controller is connected to the drive motor.

According to embodiments of the present disclosure in a third aspect, a vehicle is provided which includes the drive motor according to any one of the above embodiments.

### BRIEF DESCRIPTION OF THE DRAWINGS

FIG. 1 is a schematic view showing a drive motor according to an embodiment of the present disclosure.

FIG. 2 is a schematic view showing a stator core of a drive motor according to an embodiment of the present disclosure.

FIG. 3 is a schematic view showing a motor housing of a drive motor according to an embodiment of the present disclosure.

FIG. 4 is a schematic view showing a motor housing of a drive motor according to an embodiment of the present disclosure, in which a front end cover and a rear end cover of the motor housing are shown.

FIG. 5 is a schematic view showing a front end cover according to an embodiment of the present disclosure.

FIG. 6 is a schematic view showing a rear end cover according to an embodiment of the present disclosure.

FIG. 7 is a schematic view showing a stator core of a drive motor according to another embodiment of the present disclosure.

FIG. 8 is a schematic view showing a stator lamination of a stator core of a drive motor according to an embodiment of the present disclosure.

FIG. 9 is a partial enlarged schematic view showing the stator lamination illustrated in FIG. 8.

FIG. 10 is another partial enlarged schematic view showing the stator lamination illustrated in FIG. 8.

FIG. 11 is yet another partial enlarged schematic view showing the stator lamination illustrated in FIG. 8.

FIG. 12 is a curve graph showing a coefficient k₁, a pressure drop, and a motor maximum temperature rise rate according to an embodiment of the present disclosure.

FIG. 13 is a curve graph showing a coefficient k₂, a pressure drop, and a motor maximum temperature rise rate according to an embodiment of the present disclosure.

FIG. 14 is a schematic view showing a drive motor according to another embodiment of the present disclosure.

FIG. 15 is a schematic view showing a stator lamination according to yet another embodiment of the present disclosure.

FIG. 16 is a schematic view showing a stator core of a drive motor according to yet another embodiment of the present disclosure.

FIG. 17 is a schematic view showing a stator core of a drive motor according to still another embodiment of the present disclosure.

FIG. 18 is a curve graph showing a central angle between a projection of a center of a fluid inlet of a drive motor on a cross section of a stator core and a projection of a center of at least one cut edge on a cross section of a stator core, a pressure drop, and a motor maximum temperature rise rate according to an embodiment of the present disclosure.

### REFERENCE NUMERALS SHOWN IN THE FIGURES ARE PROVIDED AS FOLLOWS

motor housing 1, housing groove 11, fluid inlet 12, inner peripheral wall 14, fluid outlet 13, 15, front end cover 16, rear end cover 17

stator core 2, cut edge 21, stator groove 22, stator circumferential groove 23, first groove group 221, second groove group 222, first section 2221, second section 2222.

### DETAILED DESCRIPTION OF EMBODIMENTS

Certain embodiments of the present disclosure are described in detail below, examples of which are illustrated in the accompanying drawings. Certain embodiments described below with reference to the accompanying drawings are exemplary and are intended to be used to explain the present disclosure, rather than construed as a limitation to the present disclosure.

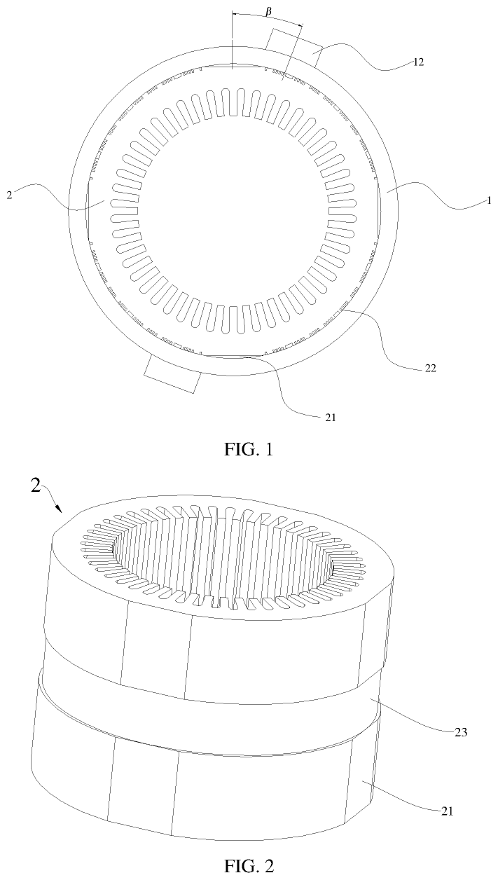

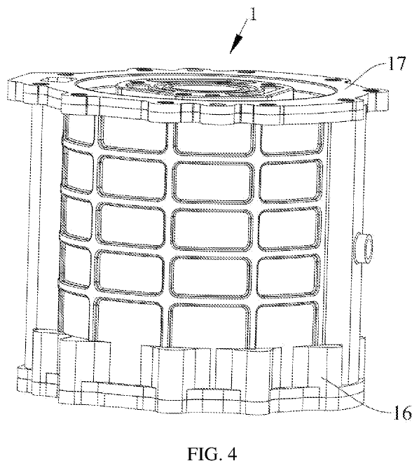

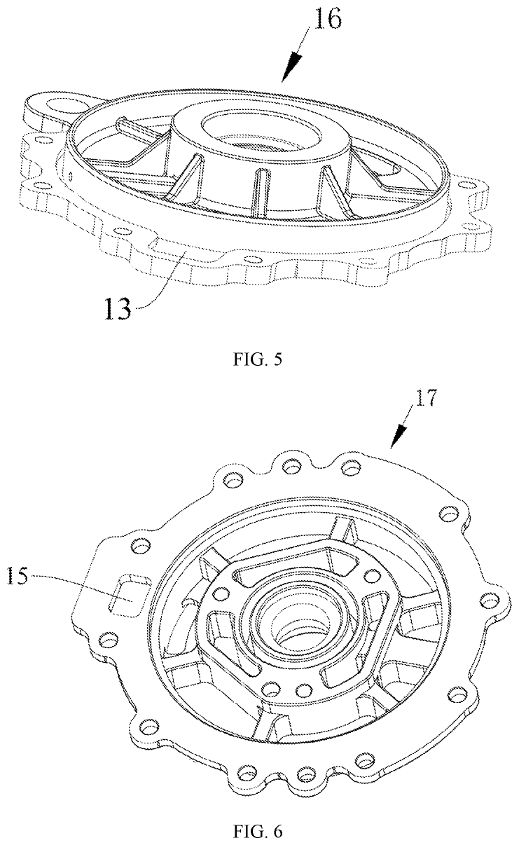

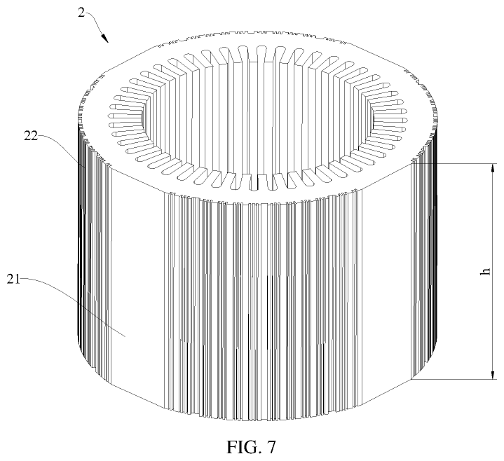

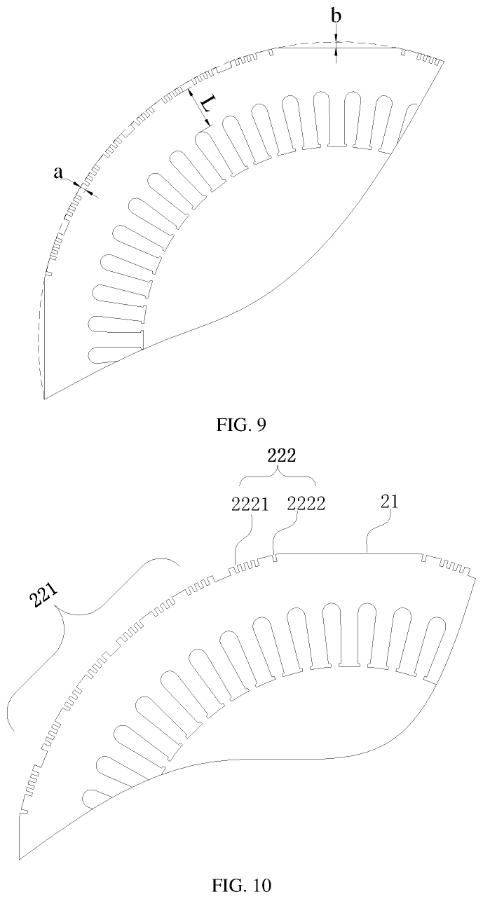

A motor according to embodiments of the present disclosure is described below with reference to FIGS. 1 to 18.

As illustrated in FIG. 1 to FIG. 6, according to certain embodiments of the present disclosure, a drive motor includes a motor housing 1 and a stator core 2. A rotor (not illustrated) may be disposed in the stator core 2. The stator tooth of the stator core 2 are wounded round by stator windings (not illustrated), thereby constituting a stator of the drive motor. The stator core 2 is mounted in the motor housing 1.

The motor housing 1 has a fluid inlet 12 and fluid outlets 13, 15. The fluid outlet 13 is usually defined on a front end cover of the motor housing 1, and the fluid outlet 15 is usually defined on a rear end cover 17 of the motor housing 1.

An outer peripheral wall of the stator core 2 has at least one cut edge 21 extending in an axial direction of the stator core. A cooling fluid flow path is formed by a space between the cut edge 21 and an inner peripheral wall 14 of the motor housing 1. The fluid inlet 12 and the fluid outlet are in communication with the cooling fluid flow path. The cut edge 21 has a depth satisfying a relationship of

$$b = \frac{{k}_{2} Lh}{{R}_{out} - {R}_{in}} ,$$

where b is the depth of the cut edge, Rₒᵤₜ is an outer diameter of the stator core, Rᵢₙ is an inner diameter of the stator core, L is a yoke thickness of the stator core, h is a stacking thickness of the stator core, and k₂ is a coefficient ranging from 0.05 to 0.1.

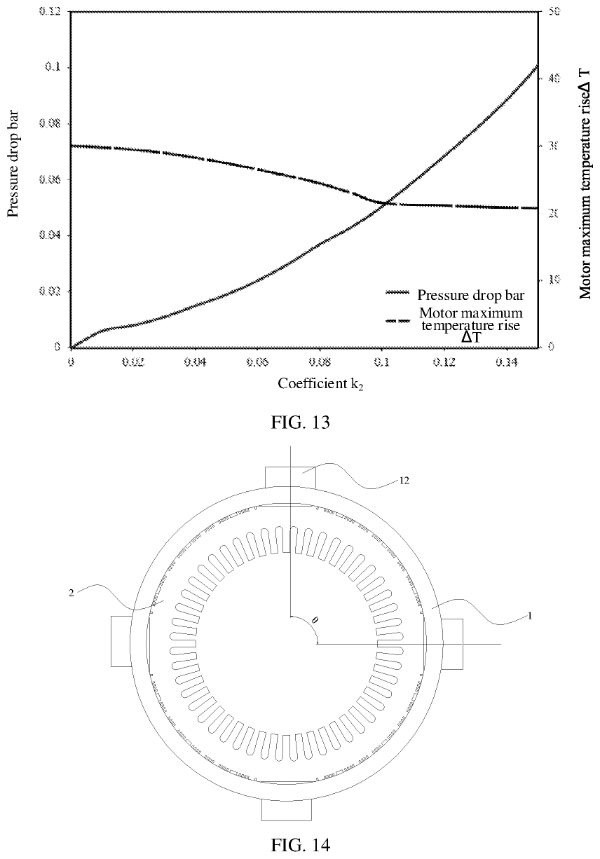

It has been found through inventors' research that, as illustrated in FIG. 13, as the coefficient k₂ increases, a pressure drop of cooling fluid increases (i.e., a flow resistance increases), and a maximum temperature rise of the motor gradually decreases. The lower the pressure drop, the better a cooling effect. The smaller the maximum temperature rise of the motor, the better service life and performance of the motor. Through thoroughly research, it is selected that the coefficient k₂ ranges from 0.05 to 0.1 to get a great thermal performance of the motor, meanwhile a raw material can be reduced by 5.3% by providing the cut edge.

A stator groove 22 is defined on the outer peripheral wall of the stator core 2 and extends in an axial direction of the stator core 2. The stator groove 22 is in communication with the fluid inlet 12 and the fluid outlet. A part of the cooling fluid flow path is defined by an inner peripheral wall surface of the motor housing 1 and the stator groove 22. Thus, it is possible to increase a contact area between the cooling fluid and the stator core 2, which can improve heat dissipation efficiency.

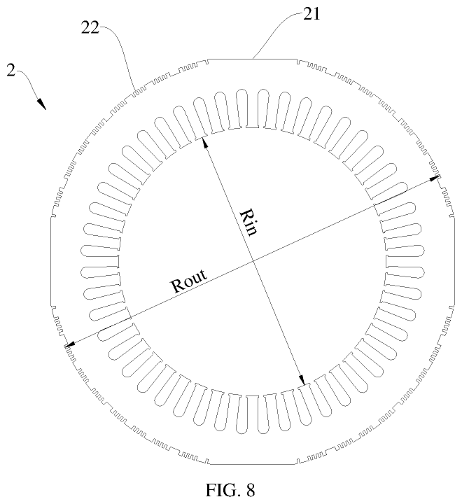

As illustrated in FIG. 8 to FIG. 11, the stator groove 22 is of a rectangular shape, and has a depth satisfying a relationship of

$$a = \frac{{k}_{1} Lh}{{R}_{out} - {R}_{in}} ,$$

where α is the depth of the stator groove, Rₒᵤₜ is the outer diameter of the stator core, Rᵢₙ is the inner diameter of the stator core, L is the yoke thickness of the stator core, h is the stacking thickness of the stator core, and k₁ is a coefficient ranging from 0.05 to 0.1.

The inventors have found through research that, as illustrated in FIG. 12, as the coefficient k₁ gradually increases, the pressure drop of the cooling fluid increases (i.e., the flow resistance of the cooling fluid increases), and a temperature rise of the motor decreases. Moreover, when k₁ is in a range of 0 to 0.05, the pressure drop of the cooling fluid increases faster. When k₁ is greater than 0.1, the pressure drop of the cooling fluid increases, but reduction of the temperature rise of the motor remains substantially unchanged.

It can be seen from the above relationship that as k₁ increases, the depth of the stator groove increases, and a contact area between the stator groove and the cooling fluid increases. Since convection heat resistance and a convective heat transfer coefficient are inversely proportional to a contact area between the cooling fluid and the housing, the smaller the thermal resistance, the stronger a heat exchange capability. Therefore, it is better for the greater contact area between the cooling fluid and the stator core 2. However, the greater the contact area, the higher a flow velocity and the greater the flow resistance. Considering the above factors comprehensively, it is beneficial for a value of k₁ to range from 0.05 to 0.1.

In some embodiments, the depth α of the stator groove 22 is greater than or equal to 1.5 millimeters and smaller than or equal to 2.5 millimeters. The inventors have found that when the depth α of the stator groove is set as 1 mm, the electromagnetic performance of the motor is reduced by 0.67%. When the depth α of the stator groove is set as 2 mm, the electromagnetic performance of the motor is reduced by 1.5%. When the depth α of the stator groove is set as 3 mm, the electromagnetic performance is reduced by 4.83%. Thus, it is beneficial to set the depth α of the stator groove to range from 1.5 mm to 2.5 mm.

In some exemplary embodiments, the depth α of the stator groove 22 can be set as 2 mm A width a of the stator groove 22 can be set as 1 mm. As described above, when the depth α of the stator groove is 2 mm, the electromagnetic performance of the motor is reduced by 1.5%, despite a certain relatively small influence on the electromagnetic performance. Meanwhile, in this case, due to the relatively greater contact area between the cooling fluid and the stator core, it can also effectively improve the cooling efficiency of the motor.

As illustrated in FIGS. 8 to 11, in some embodiments, a plurality of stator grooves 22 is divided into a plurality of groups of stator grooves 22, and the plurality of groups of stator grooves 22 is evenly arranged at intervals in a circumferential direction of the stator core 2. A central angle θ₁ corresponding to a spacing between adjacent groups of stator grooves ranges from 1 degree to 5 degrees.

In some embodiments, the plurality of stator grooves 22 is divided into first groove groups 221 and second groove groups 222. The cut edge 21 is located in the second groove groups 222. The first groove groups 221 and the second groove groups 222 are arranged alternately in the circumferential direction of the stator core 2, and are distributed at intervals. Each of the second groove groups 222 includes a first section 2221 and a second section 2222. The first section 2221 is close to the first groove group 221, and the second section 2222 is close to the cut edge 21. The number of the stator grooves 22 of the first section 2221 is greater than the number of the stator grooves 22 of the second section 2222. Since the cut edge 21 is located in the second groove groups 222, one first section 2221 and one second section 2222 are located at two sides of the cut edge 21, respectively. That is, each of the second groove groups 222 has two first sections 2221 and two second sections 2222. A central angle θ₃₂ corresponding to a spacing between a first section 2221 and a second section 2222 adjacent to the first section 2221 ranges from 1 degree to 5 degrees. A central angle θ₄₂ corresponding to a spacing between stator grooves 22 of each section ranges from 0.5 degree to 2 degrees. A central angle θ₅₂ corresponding to each of the stator grooves 22 ranges from 0.5 degree to 2 degrees.

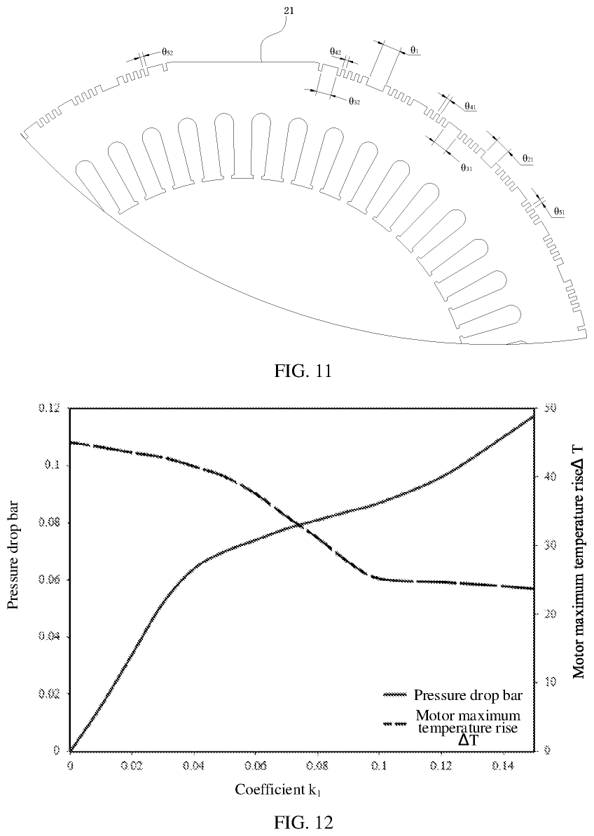

As illustrated in FIG. 11, each of the first groove groups is divided into a plurality of sets. FIG. 11 shows two sets. Each of the plurality of sets includes a plurality of sections, and FIG. 11 illustrates three sections. A central angle θ₂₁ which corresponding to a spacing between adjacent sets ranges from 1 degree to 5 degrees. A central angle θ₃₁ which corresponding to a spacing between adjacent sections of each of the plurality of sets ranges from 1 degree to 5 degrees. A central angle θ₄₁ which corresponding to a spacing between stator grooves 22 of each of the plurality of sections of each of the plurality of sets ranges from 0.5 degree to 2 degrees. A central angle θ₅₁ which corresponding to each of the stator grooves 22 ranges from 0.5 degree to 2 degrees. In some embodiments, a central angle corresponding to the cut edge 21 is 23 degrees.

By dividing the stator grooves as described above, the cooling effect can be effectively improved.

In some embodiments, a plurality of fluid inlets are spirally distributed along the motor housing. The inventors have found through research that, at the area which is closer to the fluid inlets 12, better cooling effect of the motor can be achieved. Therefore, by properly arranging the plurality of the fluid inlets 12, cooling capacity of the cooling fluid can be enhanced, and thus the heat dissipation effect of the motor can be improved. In other embodiments, the plurality of the fluid inlets 12 is arranged at intervals in an axial direction of the motor housing 1. That is, the plurality of fluid inlets 12 is arranged at intervals along a circumferential direction of the motor housing 1, and is further arranged at intervals in an axial direction of the motor housing 1. For example, the plurality of fluid inlets 12 is spirally distributed on the motor housing 1.

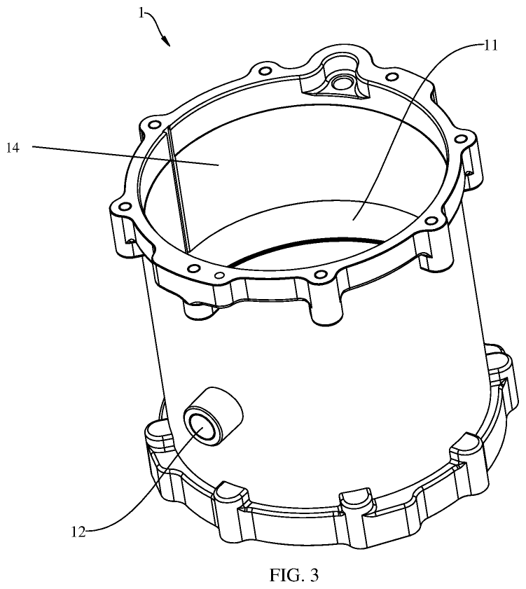

As illustrated in FIG. 3, in some embodiments, a housing groove 11 is defined on the inner peripheral wall of the motor housing 1, and extends in a circumferential direction of the motor housing. The fluid inlets 12 and the fluid outlet are in communication with the housing groove 11. The housing groove 11 is formed as a part of the cooling fluid flow path. Thus, the cooling effect is further improved.

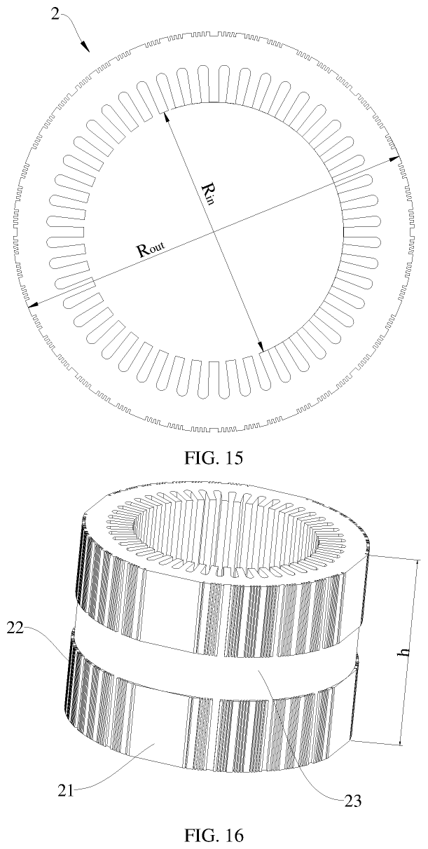

As illustrated in FIG. 1 and FIG. 15, in some embodiments, a plurality of fluid inlets 12 is provided and distributed in the circumferential direction of the motor housing 1. On a cross section of the motor housing 1, an included angle α between central axes of the adjacent fluid inlets 12 is smaller than or equal to 180 degrees. A central angle β between a projection of a center of each fluid inlet 12 and a projection of a center of the at least one cut edge 21 closest to the fluid inlet 21 on a cross section of the stator core 2 ranges from 0 degree to 5 degrees.

As shown in FIG. 1, the central angle β refers to that an included angle between a projection of a connecting line between the center of each fluid inlet and a circle center of the stator core 2 and a projection of a connecting line between a midpoint of the cut edge 21 which is closest to the fluid inlet 12 and the circle center of the stator core 2 on the cross section of the stator core 2. The included angle ranges from 0 degree to 5 degrees.

As illustrated in FIG. 18, the horizontal axis is the central angle β, the left vertical axis is the pressure drop, and the right vertical axis is the maximum temperature rise ΔT of the motor. Inventors have found through research that when the central angle β gradually increases from 0 degree to 5 degrees, increasing rate of the pressure drop (illustrated by a curve indicated by a solid line) and increasing rate of the maximum temperature rise (illustrated by a curve indicated by a dotted line) of the motor are slower (slopes of two curves are small). When the central angle β gradually increases from 5 degrees, the increasing rates of the pressure drop and the maximum temperature rise of the motor are obviously accelerated (the slopes of the two curves increase). That is, the thermal performance of the motor is poor. Therefore, it is beneficial for the central angle between the projection of the center of the fluid inlet 12 and the projection of the center of the cut edge 21 which is closest to the fluid inlet on the cross section of the stator core 2 to range from 0 degree to 5 degrees.

As illustrated in FIG. 1, in some embodiments, four cut edges 21 and two fluid inlets 12 are provided. In this case, the central angle between the projection of the center of each fluid inlet 12 and the projection of the center of the cut edge 21 which is closest to the fluid inlet 21 on the cross section of the stator core 2 is β, which can be 0 degree. In some other embodiments, as illustrated in FIG. 15, four cut edges 21 and four fluid inlets 12 are provided. The central angle β between the projection of the center of each fluid inlet 12 and the projection of the center of the cut edge 21 which is closest to the fluid inlet 21 on the cross section of the stator core 2 is 0 degree. In some embodiments, the number of the fluid inlets is smaller than the number of the cut edges, and each of the fluid inlets corresponds to one cut edge.

The stator core 2 is formed by stacking stator laminations. The stator laminations are usually made of a silicon steel sheet. At least one stator circumferential groove 23 is defined on the outer peripheral wall of the stator core 2, and extends in a circumferential direction of the stator core 2. A stator core segment where the stator circumferential groove 23 is located is referred to as a groove core segment. The remaining stator core segments are referred to as non-groove core segments. The number of the groove core segments is the same as the number of the stator circumferential grooves 23.

By providing the stator circumferential groove 23, it is possible to increase the contact area between the cooling fluid and the stator core 2, and thus improve the heat dissipation efficiency. Further, it can effectively minimize costs of the product and its manufacturing.

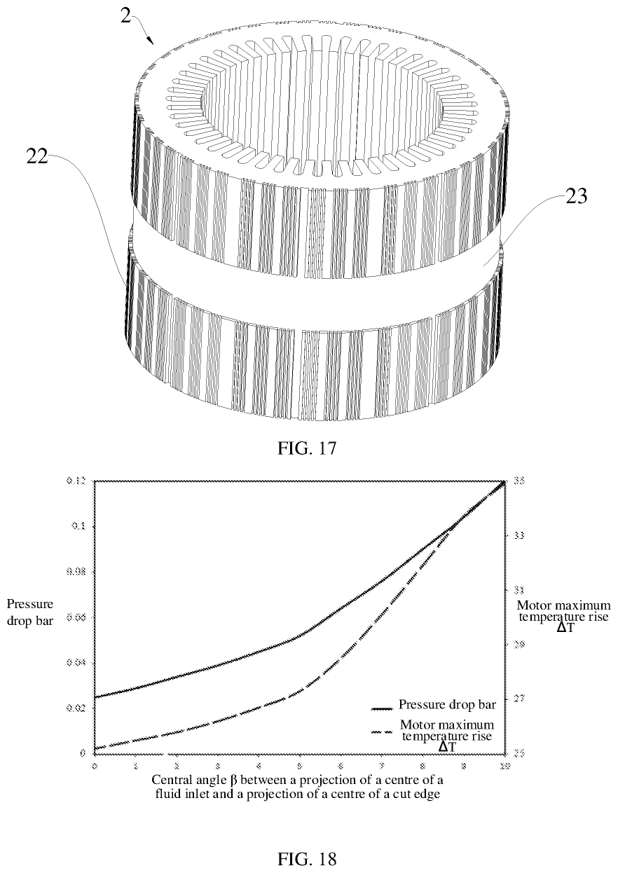

As illustrated in FIG. 17, in some embodiments, one groove core segment and two non-groove core segments are provided, and the stator groove 22 in communication with the stator circumferential groove 23 are defined on an outer peripheral wall of each of the two non-groove core segments. As illustrated in FIG. 2, in other embodiments, one groove core segment and two non-groove core segments are provided, and the cut edge 21 is disposed on the outer peripheral wall of each of the two non-groove core segments. As illustrated in FIG. 16, in the other embodiments, one groove core segment and two non-groove core segments are provided, and both the stator groove 22 and the cut edge 21 are disposed on the outer peripheral wall of each of the two non-groove core segments.

One or more groove core segments may be provided, and the present disclosure is not limited herein.

In some embodiments, one groove core segment is in communication with the fluid inlet 12. That is, one stator circumferential groove is in communication with the fluid inlet 12. The groove core segment is located at an axial middle position of the stator core 2. In some embodiments, a central axis of the fluid inlet 12 is located in a central cross section of the one groove core segment.

The groove core segment is in communication with the fluid inlet 12. For example, after the cooling fluid enters the motor housing, the stator circumferential groove 23 at the groove core segment is filled with the cooling fluid firstly. Then, the cooling fluid is brought into in full contact with the outer peripheral wall of the stator core 2 through the stator grooves 22 and the cut edge 21, and is finally discharged through the fluid outlet 13. For the flowing process of the cooling fluid, the cooling fluid flows from a middle position towards two ends. The cooling fluid can be quickly in total contact with the stator core 2 to dissipate the heat. Thus, the heat dissipation efficiency can be improved.

According to embodiments of the present disclosure in a second aspect, a drive system is provided. The drive system includes a decelerator, a controller, and the drive motor as described above. The decelerator is connected to a motor shaft of the drive motor. The controller is connected to the drive motor.

According to embodiments of the present disclosure in a third aspect, a vehicle is provided. The vehicle includes the drive motor according to certain embodiments of the present disclosure. The vehicle may be a new energy vehicle. The new energy vehicle includes a pure electric vehicle, an extended-range electric vehicle, a hybrid vehicle, a fuel cell electric vehicle, a hydrogen engine vehicle, and the like.

In the description of the present disclosure, it should be understood that, the orientation or position relationship indicated by the terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc., is based on the orientation or position relationship shown in the drawings, and is merely for the convenience of describing the present disclosure and simplifying the description, rather than indicating or implying that the associated device or element must have a specific orientation, or be constructed and operated in a specific orientation, and therefore cannot be understood as a limitation to the present disclosure.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality” means at least two, such as two, three, etc., unless otherwise specifically defined.

In the description of this specification, descriptions with reference to the terms “an embodiment”, “some embodiments”, “examples”, “specific examples”, or “some examples” etc., mean that specific features, structure, materials or characteristics described in conjunction with certain embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, those skilled in the art can combine the different embodiments or examples and the features of the different embodiments or examples described in this specification without contradicting each other.

Although certain embodiments of the present disclosure have been shown and described above, it should be understood that the above embodiments are exemplary and should not be construed as limiting the present disclosure. Those of ordinary skill in the art can make changes, modifications, substitutions and variations to the above embodiments within the scope of the present disclosure.

What is claimed is:

1. A drive motor comprising:
a motor housing having at least one fluid inlet and a fluid outlet; and
a stator core in the motor housing, an outer peripheral wall of the stator core having at least one cut edge extending in an axial direction of the stator core,
wherein:
a cooling fluid flow path is formed by a space between the at least one cut edge and an inner peripheral wall of the motor housing;
the at least one fluid inlet and the fluid outlet are in communication with the cooling fluid flow path; and
the cut edge has a depth satisfying a relationship of
$$b = \frac{{k}_{2} Lh}{{R}_{out} - {R}_{in}} ,$$
where b is the depth of the cut edge, Rₒᵤₜ is an outer diameter of the stator core, Rᵢₙ is an inner diameter of the stator core, L is a yoke thickness of the stator core, h is a stacking thickness of the stator core, and k₂ is a coefficient ranging from 0.05 to 0.1.

2. The drive motor according to claim 1, wherein at least one stator groove is defined on the outer peripheral wall of the stator core and extends in the axial direction of the stator core, the at least one stator groove being in communication with the at least one fluid inlet and the fluid outlet.

3. The drive motor according to claim 2, wherein:
the at least one stator groove is of a rectangular shape;
the at least one stator groove has a depth satisfying a relationship of
$$a = \frac{{k}_{1} Lh}{{R}_{out} - {R}_{in}} ,$$
where α is the depth of the stator groove, Rₒᵤₜ is the outer diameter of the stator core, Rᵢₙ is the inner diameter of the stator core, L is the yoke thickness of the stator core, h is the stacking thickness of the stator core, and k₁ is a coefficient ranging from 0.05 to 0.1.

4. The drive motor according to claim 2, wherein:
the at least one stator groove comprises a plurality of stator grooves divided into a plurality of groups of stator grooves, the plurality of groups of stator grooves being evenly distributed at intervals in a circumferential direction of the stator core; and
a central angle corresponding to a spacing between adjacent groups of stator grooves ranges from 1 degree to 5 degrees.

5. The drive motor according to claim 4, wherein:
the plurality of groups of stator grooves is divided into first groove groups and second groove groups that are arranged alternately in the circumferential direction of the stator core; and
the at least one cut edge is located in the second groove groups.

6. The drive motor according to claim 5, wherein:
each of the second groove groups is divided into two first sections adjacent to a corresponding first groove group, and two second sections adjacent to a corresponding cut edge, wherein:
the number of stator grooves of each of the first sections is greater than the number of stator grooves of each of the second sections,
a central angle corresponding to a spacing between a first section and a second section adjacent to the first section ranges from 1 degree to 5 degrees,
a central angle corresponding to a spacing between stator grooves of each section ranges from 0.5 degree to 2 degrees, and
a central angle corresponding to each of the stator grooves ranges from 0.5 degree to 2 degrees.

7. The drive motor according to claim 5, wherein:
each of the first groove groups is divided into a plurality of sets, each of the plurality of sets comprising a plurality of sections, wherein:
a central angle corresponding to a spacing between adjacent sets ranges from 1 degree to 5 degrees;
a central angle corresponding to a spacing between adjacent sections of each of the plurality of sets ranges from 1 degree to 5 degrees;
a central angle corresponding to a spacing between stator grooves of each of the plurality of sections of each of the plurality of sets ranges from 0.5 degree to 2 degrees; and
a central angle corresponding to each of the stator grooves ranges from 0.5 degree to 2 degrees.

8. The drive motor according to claim 2, wherein the at least one stator groove has a depth ranging from 1.5 mm to 2.5 mm.

9. The drive motor according to claim 1, wherein the at least one fluid inlet comprises a plurality of fluid inlets spirally distributed along the motor housing.

10. The drive motor according to claim 1, wherein:
a housing groove is defined on the inner peripheral wall of the motor housing, and extends in a circumferential direction of the motor housing; and
the at least one fluid inlet and the fluid outlet are in communication with the housing groove, respectively.

11. The drive motor according to claim 1, wherein:
the at least one fluid inlet comprises a plurality of fluid inlets distributed in a circumferential direction of the motor housing;
an included angle between central axes of adjacent fluid inlets is smaller than or equal to 180 degrees; and
a central angle between a projection of a center of each fluid inlet and a projection of a center of the at least one cut edge which is closest to the fluid inlet on a cross section of the stator core ranges from 0 degree to 5 degrees.

12. The drive motor according to claim 11, wherein:
the at least one cut edge comprises four cut edges;
the at least one fluid inlet comprises two fluid inlets; and
the central angle is 0 degree.

13. The drive motor according to claim 11, wherein:
the at least one cut edge comprises four cut edges;
the at least one fluid inlet comprises four fluid inlets; and
the central angle is 0 degree.

14. The drive motor according to claim 13, wherein the four fluid inlets are arranged at intervals in an axial direction of the motor housing.

15. The drive motor according to claim 1, wherein:
the stator core is formed by stacking stator laminations; and
at least one stator circumferential groove is defined on the outer peripheral wall of the stator core, and extends in a circumferential direction of the stator core, to divide the stator core into a plurality of non-groove core segments and at least one groove core segment in the axial direction of the stator core.

16. The drive motor according to claim 15, wherein:
one groove core segment and two non-groove core segments are provided;
the stator groove or the at least one cut edge is disposed on an outer peripheral wall of each of the two non-groove core segments.

17. The drive motor according to claim 16, wherein the one groove core segment is located at an axial middle position of the stator core.

18. The drive motor according to claim 17, wherein a central axis of the at least one fluid inlet is located in a central cross section of the one groove core segment.

19. A drive system comprising:
a decelerator;
a controller; and
the drive motor according to claim 1, wherein:
the decelerator is connected to a motor shaft of the drive motor; and
the controller is connected to the drive motor.

20. A vehicle comprising the drive motor according to claim 1.
